(19) United States
(12) Patent Application Publication
(10) Pub. No.: US 2011/0045350 A1
(43) Pub. Date: Feb. 24, 2011

(54) MESOPOROUS MATERIALS FOR ELECTRODES

(75) Inventors: Katherine Elizabeth Amos, Eastleigh (GB); Tobias James Gordon-Smith, Eastleigh (GB); Alan Daniel Spong, Hedge End (GB)

Correspondence Address: FOLEY & LARDNER LLP, P.O. BOX 80278, SAN DIEGO, CA, 92138-0278, US

(73) Assignee: Nanotecture Ltd.

(21) Appl. No.: 12/920,028

(22) PCT Filed: Feb. 27, 2009
(86) PCT No.: PCT/GB09/00551

§ 371 Date: Nov. 10, 2010

(30) Foreign Application Priority Data
Feb. 29, 2008 (GB) 0803868.9

(51) Int. Cl. H01M 4/32; H01M 4/42; H01M 4/46; H01M 4/485; H01M 4/50; H01G 9/00; H01M 4/88

(52) U.S. Cl. 429/219; 429/209; 429/231.1; 429/220; 429/223; 429/224; 429/231.3; 429/231.5; 429/221; 361/523; 252/182.1

(57) ABSTRACT

Mesoporous electrode materials with large particle size where the majority of particles have sizes in excess of 15 μm have a well connected internal mesopore network, and have high power capability when used as intercalation materials for a range of battery and supercapacitor chemistries that rely on intercalation mechanisms to store charge.

The present invention relates to mesoporous materials which are especially suitable for use in the electrodes of electrochemical cells, including capacitors, supercapacitors and batteries.

The mesoporous materials used in the present invention are sometimes referred to as “nanoporous”. However, since the prefix “nano” strictly means 10⁻⁹, and the pores in such materials may range in size from 10⁻⁸ to 10⁻⁹ m, it is better to refer to them, as we do here, as “mesoporous”. However, the term “nanoparticle”, meaning a particle having a particle size of generally nanometer dimensions, is in such widespread use that it is used here, despite its inexactitude.

As used herein, the term “electrochemical cell” or “cell” means a device for storing and releasing electrical energy, whether it comprises one positive/negative electrode pair or a plurality of electrodes.

Although, strictly speaking, the term “battery” means an arrangement of two or more cells, it is used here with its common meaning of a device for storing and releasing electrical energy, whether it comprises one cell or a plurality of cells.

EP 0993512 describes the preparation of mesoporous (“nanoporous”) metals having an ordered array of pores by electrodeposition from an essentially homogeneous lyotropic liquid crystalline phase formed from a mixture of water and a structure directing agent. The resulting films of mesoporous metals are said to have many uses, including in electrochemical cells.

EP963266 describes a similar process except that the metal is formed by chemical reduction.

EP 1570534 and EP 1570535 describe the use of these and other mesoporous materials, including the metal oxides and hydroxides, in electrodes and in electrochemical cells and devices containing them.

EP 1741153 describes an electrochemical cell containing titanium dioxide and/or a lithium titanate, which may be mesoporous, as the negative electrode in a cell containing lithium and hydroxide ions.

Batteries such as lithium ion (rechargeable) batteries, lithium (non-rechargeable) batteries, nickel cadmium batteries and nickel metal-hydride batteries and some asymmetric supercapacitor types of cell employ battery type electrodes store electrical charge by performing electrochemical intercalation/insertion reactions in the active material of at least one of the electrodes in these battery types. In their simplest form, intercalation reactions generally occur according to a mechanism involving the movement of ions into and out of the solid active material as charging and discharging occurs. The intercalation of ions occurs in a particular charging/discharging voltage range, reflecting the ease with which ions can be inserted into or extracted from a particular material. Spacings that exist in these materials as a result of the atomic framework characteristic to each material provide transport pathways for the intercalated ions. Different host (active) materials have different atomic framework structures and the spacings in these materials also vary such that different material types may accommodate different ion types at different voltages. However, in general, intercalation reactions tend to function according to the same basic mechanism whether they involve lithium ions (Li⁺), as in the case of lithium ion batteries, or hydroxide ions (OH⁻) and/or protons (H⁺), in the case of nickel metal hydride and nickel cadmium batteries or supercapacitors using nickel hydroxide type positive electrodes. The Handbook of Battery Materials edited by J. O. Besenhard (ISBN 3-527-29469-4) gives an excellent overview of different lithium ion battery materials that function as charge storage materials by allowing the movement of lithium ions within atomic spacings of various materials such as lithium cobalt oxide (LiₓCoO₂), lithium manganese oxide (LiₓMn₂O₄), lithium titanates (such as Li₄Ti₅O₁₂) and others. H. Bode and co-authors in Electrochimica Acta, Vol. 11, p. 1079, 1966 discuss the intercalation of protons and hydroxide ions in nickel hydroxide electrode materials as do R. Carbonio and V. Macagno in the Journal of Electroanalytical Chemistry, Vol. 177, p. 217, 1984.

The intercalation of ions into a solid is typically a slow process as the rate is governed by slow solid state diffusion processes. This slow process is often the rate limiting process in the wider charging and discharging reactions. For example, solid state diffusion of lithium ions in materials used as intercalation hosts in lithium ion batteries is typically characterised by diffusion coefficients in the range 10⁻⁷ cm²/s to 10⁻¹⁶ cm²/s. In contrast, the transport of lithium ions in the electrolyte where the electrolyte is a liquid, such as ethylene carbonate, is typically of the order of 10⁻⁶ cm²/s. As such, in the interest of achieving high power density, it is advantageous to promote transportation of lithium ions in the liquid state where diffusion is much faster, than in the solid where lithium ions move much slower. This rule can also be applied to electrochemical cells in which the electrolyte is based on water and the intercalation of protons and hydroxide ions such as those described above, since in these systems diffusion of the relevant ions is slower in the solid state than in the liquid state.

The drive to improve performance in batteries and other electrochemical cell types described above has historically involved many strategies involving both compositional and structural approaches. A significant amount of work has been undertaken to increase the energy density of batteries by increasing the amount of active material that may be packed into a given volume. This could be achieved by using larger particle sizes for the active material which would result in higher tap densities being achieved. However, the use of larger particle sizes also introduces larger solid state diffusion distances, such that in order to access all of the capacity within the centre of each particle longer timescales are required. This results in a battery with poor power performance.

More recently, battery development has been driven toward achieving higher power in order to address the requirements of applications such as power tools and hybrid electric and electric vehicles. The more successful battery designs in this field have used a strategy of employing active materials in the form of nanoparticles to increase power capability. Here, particle size (diameter) has been decreased from tens of micrometers in conventional particles to in the order of 40 nanometers, greatly decreasing the solid state diffusion distance and the timescale required by ions to address all of the capacity within the active material (that is, diffuse to the centre of a particle). In the Journal of the Electrochemical Society, Vol. 153, issue 3, p. A560, 2006, for example, J. Christensen and co-authors discuss the effects of electrode material particle size on the power capability of lithium ion batteries considering both positive electrode materials (LiₓMn_{1.84}O₄) and negative electrode materials (LiₓTi₅O₁₂). The authors teach that, in the case of both materials, small particle size is required to achieve high power, with optimum particle sizes found to be below 1 μm.

The use of nanoparticles is not without drawbacks, however. In line with the above strategy, the use of smaller particle sizes reduces the packing density of active material within an electrode, thereby reducing the charge storage capacity. Handling of nanoparticles can also introduce complications into the production process due to their low tap density. In addition, there is a growing body of scientific literature that suggests that some materials which have no toxicity in large particle form acquire properties in the nanoparticle form that make them toxic to biological systems simply by virtue of their size.

We have previously described in WO2007091076 an electrochemical cell in which a mesoporous form of nickel hydroxide was used to improve the power capability of the cell. The present invention describes an improved form of mesoporous electrode material which is capable of performing intercalation or alloying reactions and which provides an electrode and electrochemical cell with increased energy density over previous versions with retention of high power capability.

In keeping with established trends known in the art we have found that increasing the particle size and therefore tap density of mesoporous electrode materials that rely on intercalation reactions, such as nickel hydroxide, manganese oxide and its lithiated form and titanium oxide and its lithiated form, and alloying reactions such as tin and its lithiated forms leads to increased electrode and electrochemical cell charge storage capacity. However, in the case of mesoporous materials, unlike conventional materials, we have surprisingly found that increasing the particle size does not observably decrease the power capability of the material or electrodes and electrochemical cells using the material. As a result, we have also surprisingly found that the use of nanoparticles (i.e. particles of dimensions generally of the order of nanometers), with or without internal porosity, is not the only option for creation of a high power material.

According to the present invention we have surprisingly found that mesoporous electrode materials with large particle size where the majority of particles have sizes in excess of 15 μm have a well connected internal mesopore network, and have high power capability when used as intercalation materials for a range of battery and supercapacitor chemistries that rely on intercalation or alloying mechanisms to store charge.

Thus, the present invention consists in an electrode material for use in an electrochemical cell, the electrode material comprising mesoporous particles, at least 75% by weight of the particles having a particle size greater than 15 μm.

In simplest terms, particle size is defined merely as the diameter of a particle. However, particle size as discussed herein is measured using sieve analysis. This is a simple and well established technique for determining particle size and operates by passing material through a series of sieves with varying hole sizes stacked on top of each other. Particles pass through openings in the sieves or not according to their size such that different particle sizes are collected on different sieves. The mass of each collected ‘fraction’ can then be measured.

In a further embodiment, the present invention provides an electrode for use in an electrochemical cell, the electrode comprising mesoporous particles, at least 75% by weight of the particles having a particle size greater than 15 μm.

In a further embodiment, the present invention provides an electrochemical cell having at least one electrode comprising mesoporous particles, at least 75% by weight of the particles having a particle size greater than 15 μm.

As used herein, the term “mesoporous particles” means particles having a porosity of at least 15%, having average pore diameters from 2×10⁻⁸ to 1×10⁻⁹ metre where this porosity is present throughout the volume of the particle. Such mesoporous materials may be prepared by liquid crystal templating technology. The preparation and use of liquid crystalline phases is disclosed in U.S. Pat. Nos. 6,503,382 and 6,203,925, the disclosures of which are incorporated herein by reference.

The porosity herein is calculated from nitrogen porosimetry (BET) measurements. In general, we have found that cycle life improves as porosity increases however the optimum porosity varies depending on the material composition and the inherent extent of swelling experienced by a particular material during cycling. For example, lithium titanate (LiₓTi₅O₁₂) experiences very little swelling on cycling as a negative electrode material in lithium ion batteries and so the optimum porosity for this material is lower than for tin-based alloys which also function as negative electrode materials in lithium ion batteries but experience much greater swelling on cycling. Too high a porosity will lead to a reduction in the amount of active material present and so may detract from cell performance. Preferably the porosity is in the range from 15% to 75%.

Although we do not wish to be limited by any theory, we believe that the surprising retention of high power capability, despite the relatively large particle size, arises because the pores of the mesoporous material facilitate access of the ions to all of the capacity, even within the centre of each particle.

In theory, the electrode could consist wholly of the mesoporous material of the present invention, in which case the active material is the whole of the electrode and the large particles (i.e. those having a particle size greater that 15 μm) should make up at least 75% by weight of the electrode. However, since a particle-based material will, in general, lack adequate structural strength, it is preferred that the electrode should comprise a substrate or current collector on which the mesoporous material is deposited. In that case, the active material, i.e. the mesoporous material, should be made up of particles, at least 75% by weight of which have a particle size greater than 15 μm. Where binders or other inactive materials, such as materials commonly added to enhance electrical conductivity, are present mixed with the active portion of the electrode, i.e. that made up of the mesoporous electrode material, these should be disregarded in assessing the amounts of particles of size greater than or less than 15 μm. Further, it may be desirable in some applications to construct an electrode for an electrochemical cell in which the active material is composed of a mixture of mesoporous material and conventional battery or supercapacitor type active electrode materials. For example, a conventional material consisting of large particles in which there is no internal mesoporosity within each particle may have high tap density and therefore high volumetric energy density but low power density by virtue of the large solid state diffusion distances. It may be advantageous for cost or performance reasons to mix such a material with a large particle size material that contains internal mesoporosity to impart high power density to the electrode and electrochemical cell constructed using such electrodes. In this way, the electrode and electrochemical cell have a combination of the properties of the two different electrode materials. In such cases where the mesoporous material is mixed with conventional active electrode materials outside the scope of the present claims, the mesoporous material component of the active material mixture should be made up of particles, at least 75% by weight of which have a particle size greater than 15 μm, disregarding the conventional material.

Mesoporous materials such as those described in the above references typically have high surface areas as a result of the large internal surfaces created by the use of a liquid crystal template. In U.S. Pat. No. 5,604,057, Nazri discussed a manganese oxide type material for use as an intercalation host in lithium ion batteries in which the particles comprising the active material had large internal surface areas up to 380 m²/g. The author observed that surface area increases with decreasing particle size such that small particle sizes were optimal for high power capability of the battery electrode material. This relationship between surface area and particle size indicates poor connectivity of the pores that impart the high internal surface area. As such, sub-micron particle sizes were described with sizes less than 0.3 μm preferred. Graetzel and co-authors in WO9959218 describe a mesoporous transition metal oxide or chalcogenide electrode material made using a liquid crystal templating agent for use in electrochemical cells. The authors demonstrate via example that mesoporous materials made using liquid crystal templates can have higher power capability than conventional intercalation materials. However, this is attained by decreasing the particle size to the nanometer range while simultaneously ensuring effective particle connectivity and mesoporosity. Further, the method of fabricating the mesoporous materials described relies on a coating process in which layers of electrode material with 0-3 μm thickness are built up one layer at a time with a drying step required after application of each layer. This is a time consuming process if electrodes of practical thickness and capacity are to be fabricated. In addition, this method requires that the substrate on which the mesoporous electrode material is coated be resistant to the high temperature (at least 400° C.) treatment required to complete the electrode material synthesis process.

Since the benefits of the present invention are believed to arise from the physical form of the particles making up the electrodes, rather than their chemical composition, these benefits will be obtained whatever material is used. Suitable materials include but are not limited to: metals, such as nickel, cadmium, platinum, palladium, cobalt, tin, copper, aluminium, ruthenium, chromium, titanium, silver, rhodium and iridium and alloys and mixtures of these; metal oxides and hydroxides, such as nickel oxide, nickel hydroxide, nickel oxy-hydroxide, manganese dioxide (MnO₂) and its lithiated form (LiₓMnO₂), cobalt oxide and its lithiated form (LiₓCoO₂), manganese oxide and its lithiated form (LiₓMn₂O₄), nickel-manganese oxides and their lithiated forms (such as Li_{y}NiₓMn₂₋ₓO₄), nickel-manganese-cobalt oxides and their lithiated forms (such as LiₓNi_{y}Mn_{z}Co_{w}O₂), nickel-cobalt-aluminium oxides and their lithiated forms (such as LiₓNi_{y}Co_{z}Al_{w}O₂), titanium oxides and their lithiated forms (such as Li₄Ti₅O₁₂); metal phosphates such as iron phosphate and its lithiated forms (such as LiFePO₄) and manganese phosphate and its lithiated forms (such as LiMnPO₄).

Materials which are particularly useful in the invention include: nickel hydroxide; nickel oxide; nickel oxy-hydroxide; manganese dioxide; nickel-manganese oxides and their lithiated forms (such as Li_{y}NiₓMn₂₋ₓO₄); titanium oxides and their lithiated forms (such as Li₄Ti₅O₁₂) and tin and tin alloys and their lithiated forms.

The mesoporous particulate material is unlikely to have sufficient mechanical strength on its own to serve as an electrode and, accordingly, it is preferably used in the electrochemical cell on or within a support, which may also function as a current collector. The support material is thus preferably electrically conductive and preferably has sufficient mechanical strength to remain intact when formed into a film which is as thin as possible. Suitable materials for use as the support include but are not limited to copper, nickel and cobalt, aluminium and nickel-plated steel. Which of these metals is preferred depends on the type of electrochemical cell chemistry used. For example, for lithium ion battery negative electrodes, the use of a copper current collector is preferred, while aluminium is preferred for use as the positive electrode current collector in lithium ion batteries. In the case of asymmetric supercapacitors that use a positive electrode based on nickel hydroxide, nickel is the preferred current collector for the positive electrode. Current collectors or substrates used may be in the form of a foil, wire mesh, porous foam, sintered plate or any other structural form known to those skilled in the art. In general, the invention as described herein may be used while obeying the normal rules of current collector selection known by those skilled in the art.

In order to enhance the conductivity of the electrode, the mesoporous particulate material is preferably mixed with an electrically conductive powder, for example: carbon, preferably in the form of graphite, amorphous carbon, or acetylene black; nickel; or cobalt. The use of additives to improve electrical conductivity in particle based electrodes is a well known strategy in the art and the present invention can make use of this invention in the same way existing materials do. If necessary, it may also be mixed with a binder, such as ethylene propylene diene monomer (EPDM), styrene butadiene rubber (SBR), carboxy methyl cellulose (CMC), polyvinyl diene fluoride (PVDF), polytetrafluoroethylene (PTFE), polyvinyl acetate or a mixture of any two or more thereof or other binder materials known to those skilled in the art. The mesoporous particulate material, electrically conductive powder and optionally the binder may be mixed with an organic solvent, such as hexane, cyclohexane, heptane, hexane, or N-methylpyrrolidone, or an inorganic solvent such as water, and the resulting paste applied to the support, after which the solvent is removed by evaporation, leaving a mixture of the porous material and the electrically conductive powder and optionally the binder. Thus, in this way, the electrode material of the present invention may be processed into an electrode using electrode formulations of the types known to those skilled in the art.

Methods for coating the electrode material paste onto a current collector include but are not limited to doctor blading, k-bar coating, slot-die coating or by roller application. These methods are known to those skilled in the art.

The electrochemical cell of the present invention may be a capacitor, supercapacitor or battery. Where it is a battery, this may be either a secondary, i.e. rechargeable, battery, or a primary, i.e. non-rechargeable, battery.

The electrochemical cells of the present invention will contain at least two electrodes. If desired, both or all of the electrodes may be made in accordance with the present invention. Alternatively, one of the electrodes may be made in accordance with the present invention and the other or others may be conventional electrodes.

When the cell is of the nickel metal-hydride (Ni-MH) battery type, the positive electrode may be based on nickel hydroxide while the negative electrode may be based on lanthanum nickel alloy (LaNi₅). Typical separators used in these cell types are based on porous polypropylene membranes while aqueous potassium hydroxide based electrolytes are commonly used. When the cell is a primary lithium battery, the positive electrode may be based on manganese dioxide, while the negative may be a lithium metal foil. Typical separators used in this cell type are based on porous polypropylene membranes while the electrolyte may consist of lithium perchlorate in a propylene carbonate/tetrahydrofuran solvent mixture. When the cell is a secondary lithium ion battery, the positive electrode may be based on lithium nickel-manganese oxide (for example LiNi_{0.35}Mn_{1.65}O₄) and the negative electrode may be based on lithium titanate (Li₄Ti₅O₁₂). Typical separators used in such cells include those based on polypropylene and polypropylene/polyethylene porous membranes while the electrolyte may consist of lithium hexafluorophosphate dissolved in a mixed ethylene carbonate/diethyl carbonate solvent. When the cell is an asymmetric supercapacitor of the alkaline type using an electrolyte based on aqueous potassium hydroxide in a polypropylene based separator, the positive electrode active material could be nickel hydroxide while the negative electrode could be based on high surface area carbon. In an asymmetric supercapacitor of the acidic type, a typical positive electrode could be based on manganese dioxide, while the negative electrode could be based on high surface area carbon with a glass mat/fibre separator and sulphuric acid electrolyte.

For a lithium ion cell, the negative electrode may comprise a liquid crystal templated mesoporous material capable of forming a lithium insertion alloy. The material capable of forming a lithium insertion alloy may be an element (a metal or metalloid) or it may be a mixture or alloy of one or more elements capable of forming a lithium insertion alloy with one or more elements which cannot form such an insertion alloy or a mixture or alloy of two or more elements each capable of forming a lithium insertion alloy. Examples of elements that are active for lithium insertion by formation of an alloy with lithium are aluminium, silicon, magnesium, tin, bismuth, lead and antimony. Copper is inactive for lithium insertion by alloy formation, but alloys of copper with an element, such as tin, which is active may themselves be active. Other inactive elements include nickel, cobalt and iron. There is an advantage in including these inactive alloying elements in that their presence effectively dilutes the active material so that less expansion occurs on cycling, leading to further improved cycle life. In the case of lithium ion negative electrode materials that operate by formation of an alloy with lithium, the preferred active element is tin, and this is most preferably used as an alloy with an inactive element, preferably copper or nickel.

The electrochemical cell also contains a positive electrode. In the case of a lithium ion cell, this may be any material capable of use as a positive electrode in a lithium ion cell. Examples of such materials include LiCoO₂, LiMnO₂, LiNiCoO₂, or LiNiAlCoO₂. Like the negative electrode, this is preferably on a support, e.g. of aluminium, copper, tin or gold, preferably aluminium.

The electrolyte likewise may be any conventional such material, for example lithium hexafluorophosphate, lithium tetrafluoroborate, lithium perchlorate, or lithium hexafluoroarsenate, in a suitable solvent, e.g. ethylene carbonate, diethylene carbonate, dimethyl carbonate, propylene carbonate, or a mixture of any two or more thereof.

The cell may also contain a conventional separator, for example a microporous polypropylene or polyethylene membrane, porous glass fibre tissue or a combination of polypropylene and polyethylene.

Preparation of the mesoporous material used as the negative electrode in the cells of the present invention may be by any known liquid crystal templating method. For example, a liquid crystalline mixture is formed and a mesoporous material is caused to deposit from it. A variety of methods can be used to effect this deposition, including electrodeposition, electroless deposition, or chemical deposition. Of course, to some extent, the method of deposition used will depend on the nature of the material to be deposited. The preparation of mesoporous materials using liquid crystalline phases is disclosed in U.S. Pat. Nos. 6,503,382 and 6,203,925, and WO2005/101548, the disclosures of which are incorporated herein by reference.

The particle size of the mesoporous material may be controlled by control of the rate of the deposition reaction that produces the electrode material. In general, slower reaction rates favour particle growth mechanisms over nucleation mechanisms, resulting in the formation of larger particles. This relationship between particle size and rate of reaction is well known to those skilled in the art.

The invention is further illustrated by the following non-limiting Examples.

### EXAMPLE 1

### Synthesis of Mesoporous Nickel Hydroxide

36 g of BC10 surfactant was added to a mixture containing 22.8 cm³ of 1.65 M nickel(II) chloride solution (aqueous) and 1.2 cm³ of 1.65 M cobalt(II) chloride solution (aqueous). The resulting paste was hand mixed until homogeneous. A second batch of 36 g of BC10 was added to 24 cm³ of 3.3 M sodium hydroxide solution (aqueous). The resulting paste was hand mixed until homogeneous.

The two mixtures were stirred together by hand until homogeneous and allowed to stand at room temperature overnight. The surfactant was removed from the resultant product via repeated washing in deionised water followed by a final wash in methanol solvent. The collected powder was dried overnight in an oven (48 hours) and then ground using a pestle and mortar.

The resulting powder had a BET surface area of 275 m² g⁻¹ and pore volume of 0.29 cm³ g⁻¹.

The tap density and particle size distribution of the mesoporous nickel hydroxide were measured using a sieve-shaker, and the results are shown in Table 1.

### EXAMPLE 2

### Synthesis of Mesoporous Nickel Hydroxide (Alternative Version)

300 g of BC10 surfactant was added to a mixture containing 190 cm³ of 3.0 M nickel(II) chloride solution (aqueous) and 10 cm³ of 3.0 M cobalt(II) chloride solution (aqueous). The resulting paste was hand mixed until homogeneous. A second batch of 300 g of BC10 was added to 200 cm³ of 6.0 M sodium hydroxide solution (aqueous). The resulting paste was hand mixed until homogeneous.

The two mixtures were stirred together using a ‘z-blade’ mixer until homogeneous and allowed to stand at room temperature overnight. The surfactant was removed from the resultant product via repeated washing in deionised water followed by a final wash in methanol solvent. The collected powder was dried overnight in an oven (48 hours) and then ground using a pestle and mortar.

The resulting powder had a BET surface area of 390 m² g⁻¹ and pore volume of 0.38 cm³ g⁻¹.

The tap density and particle size distribution of the mesoporous nickel hydroxide were measured using a sieve-shaker and the results are shown in Table 1.

### EXAMPLE 3

### Synthesis and Storage of Mesoporous Nickel Hydroxide

300 g of BC10 surfactant was added to a mixture containing 190 cm³ of 1.65 M nickel(II) chloride solution (aqueous) and 10 cm³ of 1.65 M cobalt(II) chloride solution (aqueous). The resulting paste was hand mixed until homogeneous. A second batch of 300 g of BC10 was added to 200 cm³ of 3.3 M sodium hydroxide solution (aqueous). The resulting paste was hand mixed until homogeneous.

The two mixtures were stirred together using a ‘z-blade’ mixer until homogeneous and allowed to stand at room temperature overnight. The surfactant was removed from the resultant product via repeated washing in deionised water followed by a final wash in methanol solvent. The collected powder was dried overnight in an oven (48 hours), ground using a pestle and mortar and stored for 8 weeks under ambient conditions.

After the period of storage the resulting powder had a BET surface area of 287 m² g⁻¹ and pore volume of 0.36 cm³ g⁻¹.

The tap density and particle size distribution of the mesoporous nickel hydroxide were measured using a sieve-shaker and the results are shown in Table 1.

### EXAMPLE 4

### Electrode Fabrication and Testing Using Mesoporous Nickel Hydroxide Fabricated in Example 1

9.76 grams of a 5 wt. % PVA in 50/50 (vol.) solution of ethyl alcohol/deionised water solution was added to 3.27 grams of filamentary nickel metal powder and 6.0 g of the mesoporous nickel hydroxide produced in Example 1 contained within a glass vial. These materials were then mixed for 2 minutes using a high speed overhead mixer to form a slurry.

Once mixed, the slurry was applied to a 25 cm² nickel foam substrate, which acted as the current collector component of the electrode, using a spatula to ensure foiling of the pores of the foam with the nickel hydroxide slurry. The electrode was then dried in an oven at 125° C. The dried electrode was then calendared to a thickness of 120 μm.

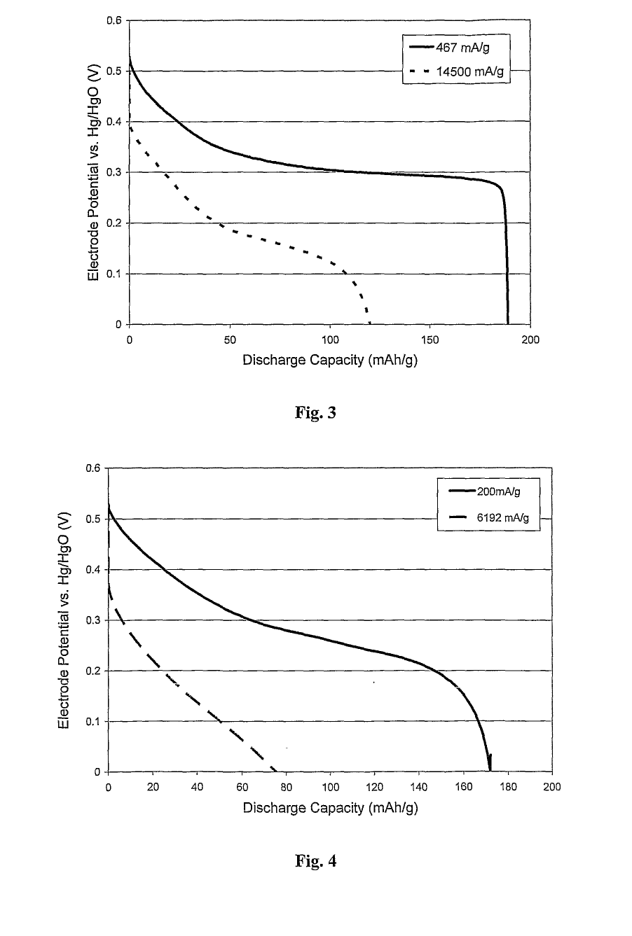

The assembled electrode was then cycled in 6 M potassium hydroxide solution using a Hg/HgO reference electrode. FIG. 3 of the accompanying drawings shows a discharge curve for the electrode using mesoporous nickel hydroxide discharged at a constant current rate of 467 mA/g. 188 mAh/g of charge storage capacity was extracted at the lower discharge rate of 467 mA/g with a flat discharge curve in which the average voltage was 0.306 V vs. Hg/HgO. At the higher discharge rate of 14,500 mA/g, a discharge capacity of 120 mAh/g was measured with an average voltage of 0.174 V.

### EXAMPLE 5

### Synthesis of Mesoporous Nickel Hydroxide (Alternative Version)

300 g of BC10 surfactant was added to a mixture containing 190 cm³ of 1.65 M nickel(II) chloride solution (aqueous) and 10 cm³ of 1.65 M cobalt(II) chloride solution (aqueous). The resulting paste was hand mixed until homogeneous. A second batch of 300 g of BC10 was added to 200 cm³ of 3.3 M sodium hydroxide solution (aqueous). The resulting paste was hand mixed until homogeneous.

The two mixtures were stirred together using a ‘z-blade’ mixer until homogeneous and allowed to stand at room temperature overnight. The surfactant was removed from the resultant product via repeated washing in deionised water followed by a final wash in methanol solvent. The collected powder was dried overnight in an oven (48 hours) and then ground using a pestle and mortar.

The resulting powder had a BET surface area of 342 m² g⁻¹ and pore volume of 0.40 cm³ g⁻¹.

The tap density and particle size distribution of the mesoporous nickel hydroxide were measured using a sieve-shaker and the results are shown in Table 1.

TABLE 1

| | % of | % of | % of | % of | |
|---|---|---|---|---|---|
| | particles >106 | particles | particles | particles <25 | Tap density/ |
| | μm | 106-53 μm | 53-25 μm | μm | g cm⁻³ |
| Example 1 | 3 | 23 | 70 | 4 | 0.98 |
| Example 2 | 22 | 58 | 19 | 1 | 0.81 |
| Example 3 | 13 | 32 | 43 | 12 | 0.80 |
| Example 5 | 2 | 49 | 40 | 9 | 0.84 |

### EXAMPLE 6

### Electrode Fabrication and Testing Using Conventional Nickel Hydroxide

The procedure for electrode preparation of Example 4 was repeated with the exception that the mesoporous nickel hydroxide was replaced by a conventional, commercially available nickel hydroxide material obtained from Tanaka Chemical Corp. with a particle size of 10.7 μm.

The assembled 120 μm thick electrode was cycled in 6 M potassium hydroxide solution using a Hg/HgO reference electrode at a number of different discharge rates. FIG. 4 of the accompanying drawings shows discharge curves for the electrode using the conventional nickel hydroxide discharged at constant current rates of 200 mA/g and 6192 mA/g. 172 mAh/g of charge storage capacity was extracted at the lower discharge rate of 200 mA/g with a sloping discharge curve in which the average voltage was 0.273 V vs. Hg/HgO. A discharge capacity of 75 mAh/g was obtained at the higher rate of 6192 mA/g and the average discharge voltage dropped to 0.147 V vs. Hg/HgO.

### EXAMPLE 7

### Mesoporous MnO₂ Templated from Pluronic F127 with TEGMME

88.0 ml of a 0.25 M sodium permanganate solution (aqueous) was added to 71.5 g of Pluronic F127 surfactant. The mixture was stirred vigorously until a homogeneous liquid crystal phase was formed, and then 3.43 ml of triethylene glycol monomethyl ether (TEGMME) was added and stirred through the mixture. The reaction vessel was sealed and then left for 3 hours in a 90° C. oven to react. The surfactant was removed from the resultant product via repeated washing in deionised water. The collected powder was dried at 60° C. for 2 days.

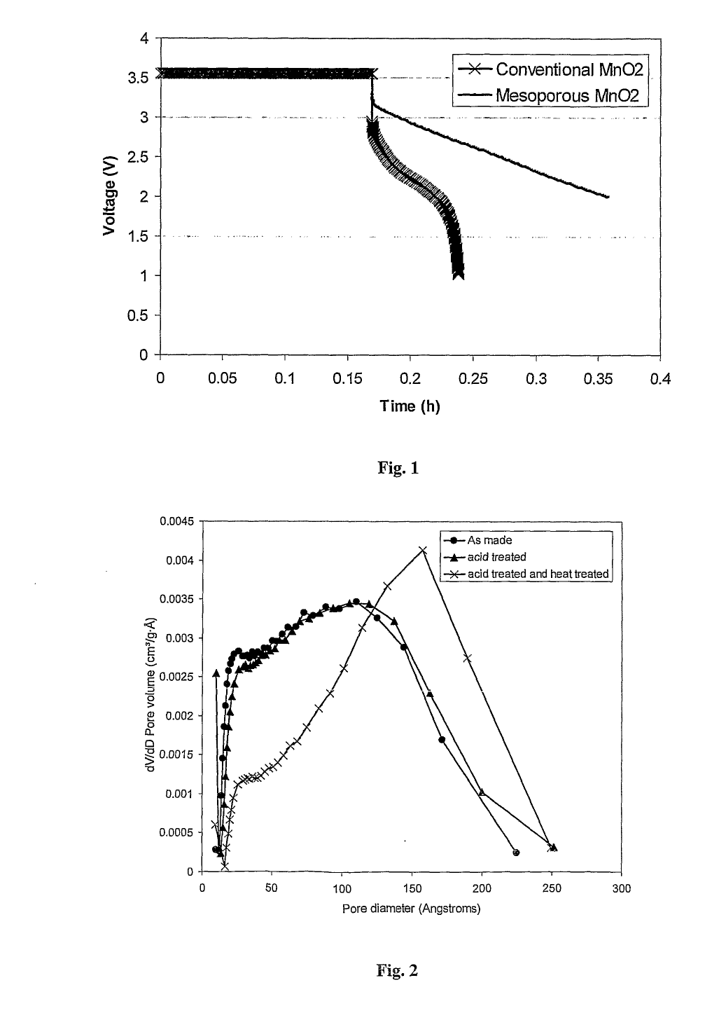

The mesoporous MnO₂ as made had a surface area of 265 m²/g and a pore volume of 0.558 cm³/g as determined by nitrogen desorption. The pore size distribution also determined by nitrogen desorption is shown in FIG. 2 of the accompanying drawings.

### Acid Treatment

2.0 g of the as made mesoporous MnO₂ was then added to 20 ml of 3.0 M nitric acid solution in a conical flask. A condenser was attached, and the solution was heated to 90° C. while stirring, after which it was held for 30 minutes. The solid was then filtered off and washed with deionised water. The powder was then dried overnight at 60° C. to remove most of the water.

The mesoporous MnO₂ after this acid treatment had a surface area of 252 m²/g and a pore volume of 0.562 cm³/g as determined by nitrogen desorption. The pore size distribution also determined by nitrogen desorption is shown in FIG. 2 of the accompanying drawings.

### Heat Treatment

After the above acid treatment the mesoporous MnO₂ powder was placed in a ceramic crucible and heated to 350° C. in a chamber furnace at a ramp rate of 1.0° C./minute under air. The furnace was then turned off and allowed to cool down overnight before the sample was removed.

The mesoporous MnO₂ after this heat treatment had a surface area of 178 m²/g and a pore volume of 0.569 cm³/g as determined by nitrogen desorption. The pore size distribution also determined by nitrogen desorption is shown in FIG. 2 of the accompanying drawings.

### EXAMPLE 8

### Preparation of Meso Porous MnO₂ Electrode

1.0 g of mesoporous MnO₂ powder was added to 0.056 g of carbon (Vulcan XC72R) and mixed by hand with a pestle and mortar for 5 minutes. Then 0.093 g of PTFE-solution (polytetrafluoroethylene suspension in water, 60 wt. % solids) was added to the mixture and mixed for a further 5 minutes with the pestle and mortar until a thick homogenous paste was formed.

The composite paste was fed through a rolling mill to produce a free standing film. Discs were then cut from the composite film using a 12.5 mm diameter die press and dried under vacuum at 120° C. for 24 hours. This resulted in a final dry composition of 90 wt. % MnO₂, 5 wt. % carbon and 5 wt. % PTFE.

### EXAMPLE 9

### Preparation of a Mesoporous MnO₂ Based Electrochemical Cell

An electrochemical cell was assembled in an Argon containing glove-box. The cell was constructed using an in-house designed sealed electrochemical cell holder. The mesoporous MnO₂ disc electrode produced in Example 8 was placed on an aluminium current collector disc and two glass fibre separators were placed on top. Then 0.5 mL of electrolyte (0.75 M lithium perchlorate in a three solvent equal mix of propylene carbonate, tetrahydrofuran and dimethoxyethane) was added to the separators. Excess electrolyte was removed with a pipette. A 12.5 mm diameter disc of 0.3 mm thick lithium metal foil was placed on the top of the wetted separator and the cell was sealed ready for testing.

### EXAMPLE 10

### Preparation of Conventional MnO₂ Electrode

The procedure of Example 8 was repeated but replacing the mesoporous MnO₂ of Example 7 with a conventional, commercially available MnO₂ powder (Mitsui TAD-1 Grade).

### EXAMPLE 11

### Preparation of a Conventional MnO₂ Based Electrochemical Cell

The procedure of Example 9 was repeated but using the positive electrode fabricated using conventional MnO₂ as described in Example 10.

### EXAMPLE 12

### Testing of a MnO₂ Based Electrochemical Cell

The discharge currents required for 1 C rate discharge of the electrochemical cells fabricated as described in Example 9 (mesoporous MnO₂) and Example 11 (conventional MnO₂) were calculated using a theoretical capacity of 308 mAh/g. The electrochemical cells were then discharge using these current values. The discharge curves for both cells are shown in FIG. 1 of the accompanying drawings.

1. An electrode material for use in an electrochemical cell, the electrode material comprising mesoporous particles, at least 75% by weight of the particles having a particle size greater than 15 μm.

2. An electrode material according to claim 1, in which the material has a porosity in the range from 15% to 75%.

3. An electrode material according to claim 1, in which at least 75% of the particles have a particle size greater than 25 μm.

4. An electrode material according to claim 1, in which at least 85% of the particles have a particle size greater than 15 μm.

5. An electrode material according to claim 1, in which at least 85% of the particles have a particle size greater than 25 μm.

6. An electrode material according to claim 1, in which the material is a metal, a metal oxide or hydroxide, a lithiated form of the oxide, a metal phosphate, or a lithiated form of the phosphate.

7. An electrode material according to claim 6, in which the metal is nickel, cadmium, platinum, palladium, cobalt, tin, copper, aluminium, ruthenium, chromium, titanium, silver, rhodium or iridium or an alloy or mixture thereof.

8. An electrode material according to claim 6, in which the metal oxide or hydroxide is nickel oxide, nickel hydroxide, nickel oxy-hydroxide, manganese dioxide (MnO₂) or its lithiated form, cobalt oxide or its lithiated form, manganese oxide or its lithiated form, a nickel-manganese oxide or its lithiated form, a nickel-manganese-cobalt oxide or its lithiated form, a nickel-cobalt-aluminium oxide or its lithiated form, or a titanium oxide or its lithiated form.

9. An electrode material according to claim 6, in which the metal phosphate is iron phosphate or its lithiated form or manganese phosphate or its lithiated form.

10. An electrode material according to claim 6, in which the material is nickel hydroxide; nickel oxide; nickel oxy-hydroxide; manganese dioxide; a nickel-manganese oxide or its lithiated form, a titanium oxide or its lithiated form or a tin alloy or its lithiated form.

11. An electrode material according to claim 1, which comprises a mixture of mesoporous particles at least 75% by weight of which have a particle size greater than 15 μm and other particles.

12. An electrode material according to claim 11, in which the other particles comprise non-mesoporous material.

13. A method for the manufacture of an electrochemical cell, said method comprising employing an electrode material according to claim 1 for the manufacture thereof.

14. A method according to claim 13, wherein the electrochemical cell is for use in a battery or capacitor.

15. An electrode for use in an electrochemical cell, the electrode comprising mesoporous particles, at least 75% by weight of the particles having a particle size greater than 15 μm.

16. (canceled)

17. An electrode according to claim 15, in which the mesoporous particles are supported on or within a substrate or current collector.

18. An electrode according to claim 15 for use in a capacitor or battery.

19. An electrochemical cell having at least one electrode according to claim 15.

20. A battery comprising an electrochemical cell according to claim 19.

21. A capacitor comprising an electrochemical cell according to claim 19.
